(19) United States
(12) Patent Application Publication
(10) Pub. No.: US 2010/0207019 A1
(43) Pub. Date: Aug. 19, 2010

(54) OPTICAL MONITORING OF FLUID FLOW

(75) Inventors: Arthur H. Hartog, Winchester (GB); Colin A. Wilson, Surrey (GB)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/705,767

(22) Filed: Feb. 15, 2010

Related U.S. Application Data
(60) Provisional application No. 61/153,284, filed on Feb. 17, 2009.

(51) Int. Cl. E21B 47/01; G01V 8/16; E21B 47/06

(52) U.S. Cl. 250/269.1; 73/152.18; 181/105

(57) ABSTRACT

A distributed vibration sensor is positioned in a wellbore to measure fluid flow. The output of the sensor is monitored to acquire a distribution of vibration along a region of interest in the wellbore. An indication of the effectiveness of a well treatment to stimulate fluid flow in the wellbore may be provided based on the acquired vibration distribution. In some embodiments, the well treatment may be adjusted based on the indication of effectiveness.

### CROSS REFERENCE TO RELATED APPLICATIONS

This application claims the benefit under 35 U.S.C. §119(e) of U.S. Provisional Application Ser. No. 61/153,284 entitled “Optical Monitoring of Flow,” filed Feb. 17, 2009, which is hereby incorporated by reference.

### BACKGROUND

The present invention relates generally to the measurement of fluid flow in downhole applications, and more particularly to downhole vibration-based optical flowmeters.

Hydrocarbon fluids, such as oil and natural gas, are obtained from a subterranean geologic formation, referred to as a reservoir, by drilling a well that penetrates the hydrocarbon-bearing formation. During the life of the well, the well may be subjected to various well treatments, such as hydro-fracturing, acidizing, jet removal of scale, etc., for the purpose of stimulating and/or improving the production of hydrocarbons from the formation. The effectiveness of various treatments generally may be determined by monitoring the characteristics of the fluid flow produced from or injected into the well either during or after the treatments. However, difficulties surrounding the measurement of fluid flow characteristics may present challenges for accurately assessing the effectiveness of a treatment and, based on that assessment, controlling and/or adjusting the application of the treatment.

### BRIEF DESCRIPTION OF THE DRAWINGS

Certain embodiments of the invention will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 is a schematic illustration of an exemplary deployed of a distributed vibration sensor (DVS) in a well according to an embodiment of the invention;

FIG. 2 is a schematic illustration an exemplary DVS system deployed across multiple wells in accordance with an embodiment of the invention;

FIG. 3 is a schematic illustration of an exemplary interrogation and data acquisition system in accordance with an embodiment of the invention; and

FIG. 4 is a flow diagram of an exemplary technique using a DVS to assess the effectiveness of a well treatment in accordance with an embodiment of the invention.

### DETAILED DESCRIPTION

In the following description, numerous details are set forth to provide an understanding of illustrative embodiments of the present invention. However, it will be understood by those skilled in the art that embodiments of the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. The terms “couple”, “coupled”, “coupling”, “coupled with”, and “coupled together” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention. Furthermore, the term “treatment fluid” includes any fluid delivered to a formation to stimulate production including, but not limited to, fracing fluid, acid, gel, foam or other stimulating fluid.

Distributed optical fiber sensing often is used to measure downhole well parameters. For instance, many well systems use optical fibers as distributed temperature sensors (DTS). In such systems, a cable containing one or more optical fibers typically is deployed proximate a region of interest in the well. The data obtained from the optical fiber(s) is used to determine various downhole parameters that are indicative of conditions or events occurring in the well. A number of distributed optical fiber sensing methodologies may be used to determine well parameters that are of interest. For instance, many DTS systems are based on the detection of Raman scattering in a reflectometric configuration. In such systems, optical time domain reflectometry and frequency domain reflectometry have both been used to determine the distribution of the temperature along the region of interest in the well based on the detected Raman scattering. Other systems detect Brillouin scattering (both stimulated and spontaneous) to determine both strain and temperature distributions in wells.

Fluid flow is another example of a parameter that is of interest in a wellbore and, of particular interest, changes in fluid flow that result from a well treatment. In some wells, DTS systems have been used to determine the effectiveness of a particular well treatment aimed at altering fluid flow in certain regions of the formation by providing temperature distributions in the region of interest both before and after the well treatment. Changes in the temperature distribution profile along the region of interest may then be used to infer the location and effectiveness of the treatment.

Although DTS systems provide many types of useful information, DTS measurements may not always be best suited in some applications. For instance, with respect to well treatments, an exemplary treatment process may include stimulation through hydrofracturing where the reservoir formation is fractured by application of a high pressure in order to increase the productivity of the well. Generally, hydrofracturing creates or activates fissures or perforations that provide an increased contact area with the reservoir. The fissures may be kept open using various techniques, such as by including propants (e.g., solid particles) in the fracturing fluid or possibly by exploiting naturally occurring shear stress in the formation. Another well treatment process may include selectively restricting flow, for example, by pumping fibers to partially obstruct flow paths. Still other treatments include acidizing (in which acid is pumped into the formation, generally to address near-borehole permeability issues) and squeezing (in which the objective is to reduce the flow from certain intervals in the well, e.g., to reduce a present or expected water cut). Yet another well treatment involves the removal of scale or other precipitated solids.

In general, these well treatments are performed to alter the local inflow or outflow (in the case of injector wells) in certain parts of the formation. In order to monitor the effectiveness of the treatment process, it is therefore important to understand the local distribution of fluid flow into or out of the well. Although DTS measurements may be used to determine inflow and outflow profiles, the temperature method can fail in certain circumstances, such as in horizontal wells, where there is no geothermal profile to provide a temperature contrast for fluids entering at various well depths. In addition, even where a DTS system is able to provide an inflow profile, it is frequently difficult to determine the composition (e.g., oil or water) of the fluid entering the well.

Accordingly, embodiments of the invention may employ distributed vibration sensing (DVS) for determining fluid flow characteristics in a well. In an exemplary embodiment, DVS may be used for monitoring (including real-time monitoring) the effectiveness of well treatments and operations. In some embodiments, information obtained from the DVS measurements also may be used to control or adjust well treatments. For instance, in some embodiments, the DVS information may be used to determine the location and extent of inflow regions in the well before, during and after a well treatment, thus providing a tool to determine the effectiveness of the treatment and/or to determine appropriate adjustments to the treatment that may be made to achieve a desired fluid flow. Towards that end, embodiments of the invention may employ distributed optical fiber sensing techniques for the acquisition of the DVS measurements.

In general, the DVS measurements provide a distribution of acoustic noise at resolvable locations along the well or least along an interval of interest. The acoustic signal may arise from any one of a number of mechanisms, including flow noise along the wellbore (i.e., axial flow), flow noise resulting from fluid passage into or out of the wellbore (i.e., radial flow), and the flow of fluid over the fiber optic cable that is deployed in the well for the DVS measurement (i.e., flow induced vibration). Once acquired, the optical signal corresponding to the acoustic noise may be interpreted based on, for example, its spectral content, the intensity of the fluctuation of the optical signal, etc. Based on the information acquired from the optical signal, information regarding the characteristics of fluid flow in the well, such as location, extent, and composition of the fluid flow, may be determined. In some embodiments, the information may be acquired before, during and/or after a well treatment so an evaluation of the effectiveness of the well treatment and corresponding adjustments may be made.

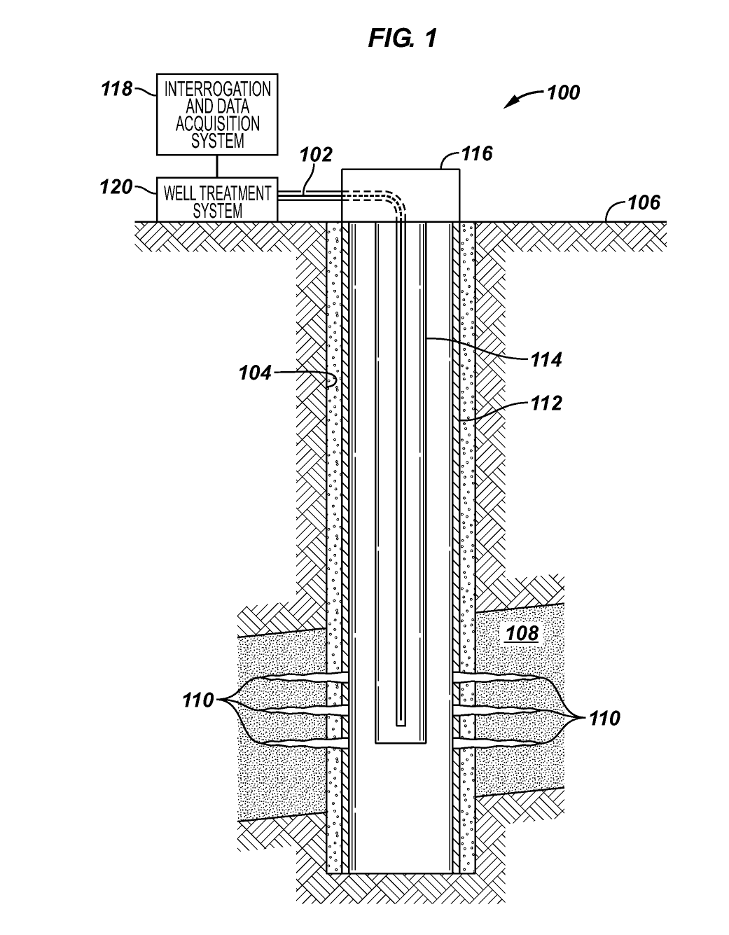

Turning now to FIG. 1, a well system 100 is illustrated in which a distributed vibration sensor (DVS) 102, i.e., a cable containing one or more optical fibers, is deployed in a wellbore 104. The wellbore 104 extends from a surface 106 into a surrounding formation 108. As can be seen in FIG. 1, a plurality of perforations 110 through which fluid may flow extend from the wellbore 104 into the formation. In this example, the well system 100 includes a casing 112 and a production tubing 114 coupled to a wellhead 116. The system 100 also includes an interrogation and data acquisition system 118 for acquiring information from the DVS 102, and a well treatment system 120 to perform a well treatment process in the wellbore 104. For instance, the well treatment system 120 may include systems and components for controlling the treatment process, such as transport systems to transport various materials (e.g., treatment fluids, propants, diversion objects, etc.) used in the treatment process into the wellbore 104, and control systems for controlling the transport of treatment materials as well as the operation of downhole equipment or components, such as valves, packers, etc.

As shown in FIG. 1, the DVS 102 may be deployed in the fluid (e.g., the treatment fluid) within the production tubing 114. In other embodiments, DVS 102 may be deployed in the annulus between the tubing 114 and the casing 112 depending on the particular application in which the DVS is employed. Regardless of the location of deployment, the DVS 102 may be deployed in a substantially bare form (i.e., such as the fiber and a primary coating only) in the fluid, or deployed encapsulated within protective layers, such as polymers or metals forming a cable.

In some cases, the force transporting the DVS 102 into the wellbore 104 may be the fluid drag produced by the deployment fluid, possibly augmented by adding weight to the cable comprising the DVS 102 (e.g., a sinker bar). The cable may be manufactured to conform externally to accepted dimensional standards in the industry for slickline, e.g. ⅛″ diameter, so as to enable deployment through existing stuffing boxes. Yet another temporary deployment option may be to install coil tubing that includes an optical cable (e.g., such as the iCoil available from Schlumberger). In such an embodiment, the coil tubing with the optical cable may be lowered in the well prior to treatment. In addition, the coil tubing may be used as part of the well treatment process. For example, the tubing may be used to transport the treatment material, e.g. such as transporting the fracturing fluid at pressure, conveying acid or other treatments, and providing locally directed work (e.g., jet removal of scale), among other functions. It should be understood that these treatments have been provided as examples only, and that the techniques described herein may be employed with other treatment processes or applications in which information about the characteristics of fluid flow is desired.

Fluid flow characteristics also may be monitored using a pre-installed DVS 102, again using known techniques. For instance, the DVS 102 may be held onto the outside of the production tubing 114, or placed in the annulus between casing 112 and tubing 114. Alternatively, a control line may be clamped or otherwise coupled to the exterior of the production tubing and the DVS 102 may be pumped through the control line after the well 100 has been completed.

In yet other embodiments, the DVS 102 may be installed at yet other locations in the wellbore, such as behind the casing 112. This deployment option may be useful in monobore completions, where the fluid flow of interest is confined within the casing rather than within a tubing within the casing. In yet other applications, the DVS 102 may be embedded within the wall of the casing 112, thus providing additional protection to the fiber optic cable. As a further example, the DVS 102 may be located inside, on or behind a screen (e.g., a perforated screen, a coiled screen, etc.) in the wellbore. In some embodiments, the screen may be located at the bottom of the production tubing 114 to prevent sand and other debris from entering the tubing 114.

Regardless of the manner in which DVS 102 is deployed, the optical cable containing the DVS 102 may include multiple optical fibers. In some cases, one or more fibers may be separately used, and none, some, or all of the fibers may have multiple cores. Such configurations may allow multiple types of optical sensors to be used to monitor multiple or different parameters within the wellbore. For instance, the fiber optic cable may include both the DVS 102 and a distributed temperature sensor (DTS). In this manner, the type of fiber best suited for sensing each parameter may be used. For instance, a distributed vibration sensor may work better on a single mode fiber, while a multimode fiber may be better suited for use as a distributed temperature sensor.

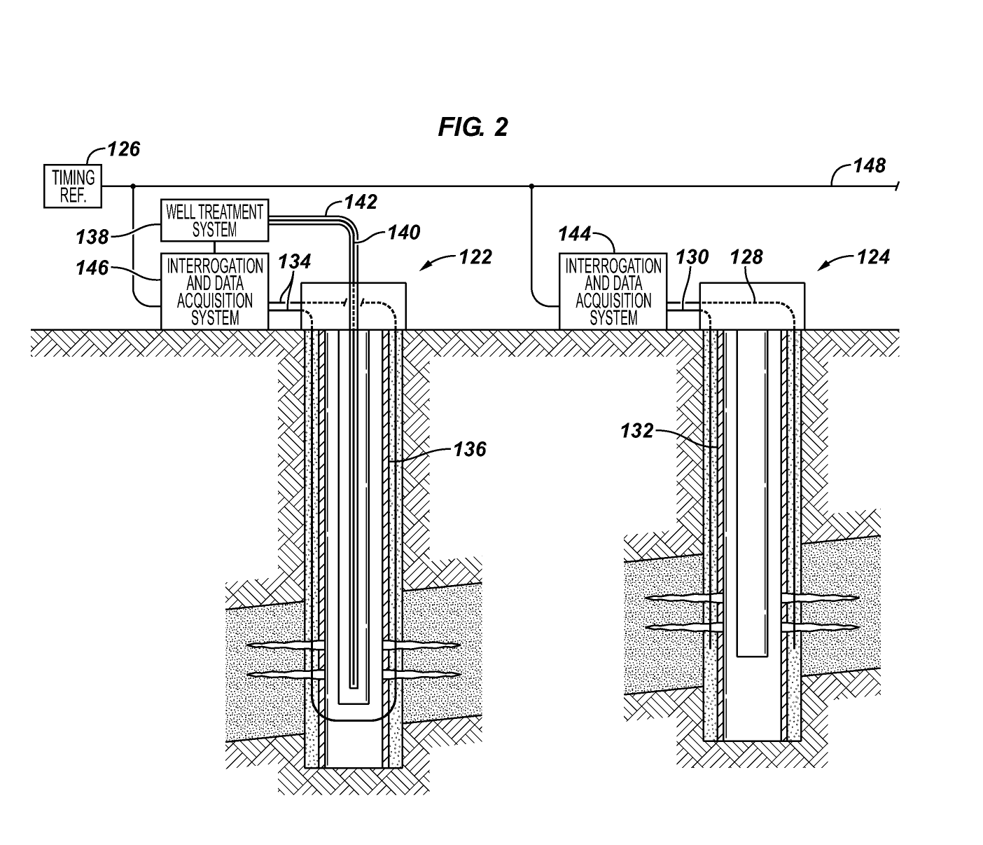

In some embodiments, the fiber optical cable may be located in a single well (as shown in FIG. 1) or in multiple wells (which may or may not include the treatment well) for simultaneous data acquisition (as shown in FIG. 2). Referring to FIG. 2, in multi-well applications, data from wells 122 and 124 may be correlated, such as by time synchronizing the data across individual wells using a timing reference 126, e.g., GPS time. In this way, events recorded in each well can be correlated with those recorded in other wells and triangulation (and thus localization) of events may be effected.

In either single well or multi-well applications, multiple fiber optics may also be employed within a particular well, thus allowing multiple measurands to be simultaneously acquired. For instance, two fiber optic cables 128 and 130 are deployed in well 124 in FIG. 2. The measurands monitored by the fiber optics 128 and 130 may include temperature and pressure, either at selected locations or as a distribution measurement. In addition, the fiber sensors may measure strain, such as on the casing 132 for example. The data obtained from the well(s) 122, 124 may be used to determine which zone in the formation is flowing before, during and after the treatment. The data may also be used to determine the composition of the produced fluids, such as including discriminating between solids, water, oil, and gas, for example. One objective may be to monitor the downhole performance of a well treatment and to be able to react during the job, for example, by diverting the fluid (e.g., by altering the injected fluid, actuating valves, dropping balls, and so on). The treatment may include a wide variety of procedures, such as hydraulic fracturing, acid stimulation, squeezing certain zones to prevent water break-through and so on.

In some embodiments, multiple optical fibers may be installed within a single well at different azimuths so as to provide some directional sensitivity and thus assist in localizing monitored events.

Referring more particularly to FIG. 2, a fiber optic sensor 134 is deployed in well 122, such as by pumping a fiber optic cable through a control line disposed on the outside of the casing 136. Fiber optic sensors 128 and 130 may be deployed in well 124 in a similar or alternative manner. Fiber optic sensors 128, 130 and 134 may be used to monitor a variety of parameters, such as temperature, pressure and/or strain. In the event that a treatment process is performed in one of the wells (e.g., in well 122 by well treatment system 138), a distributed vibration sensor 140 may be deployed in the treatment well (e.g., well 122), such as in coil tubing 142 that is used to transport the treatment fluid. As shown in FIG. 2, the data acquired from wells 122 and 124 is synchronized to the time reference 126 (e.g., a precision time reference, such as GPS time) so that events from the wells 122 and 124 can be correlated. For instance, measurements from the distributed vibration sensor 140 may be correlated with the information obtained from the sensors 128, 130 and 134, which may lead to a more thorough understanding of the effectiveness of the well treatment. In the exemplary embodiment shown, data is acquired from the sensors 128 and 130 by interrogation and data acquisition system 144, and data is acquired from sensors 134, 140 by interrogation and data system 146. The systems 144 and 146 are communicatively coupled via a communication link 148, such as a satellite communication link for instance. In other embodiments, a single interrogation and acquisition system may acquire data from all wells in the well network via the link 148.

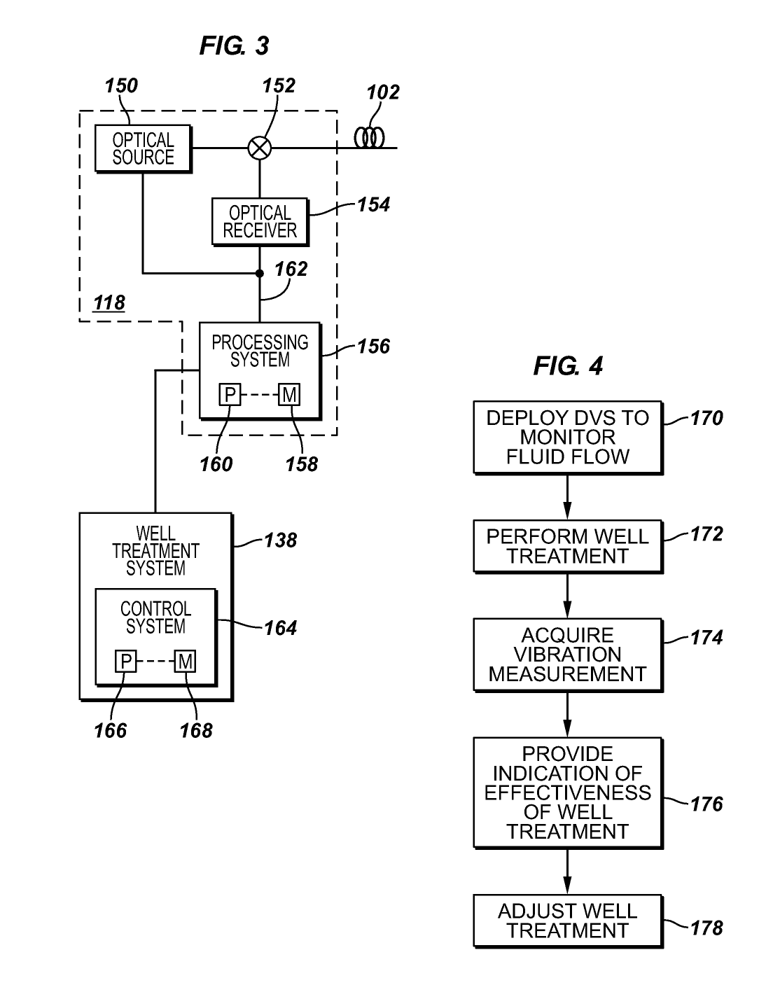

The fiber optic sensors 128, 130, 134 and 140 may be interrogated and data acquired using any of a variety of technologies and components suitable for fiber optic sensing and data acquisition. FIG. 3 generally shows an exemplary embodiment of an interrogation and data acquisition system 118 that may be implemented in the well system 100 (see FIG. 1). System 118 includes an optical source 150 to launch a pulse of light through a circulator 152 into the DVS 102. The optical source 150 may be any of a variety of optical sources suitable for the particular interrogation technique used, including a narrowband laser, a coherent optical source, a pulsed optical source, etc. The source 150 further may include appropriate circuitry, such as a modulator, to launch a light pulse having a desired pulse width and frequency. Backscattered light produced in response to the launched pulse of light is returned from the DVS 102 and received by an optical receiver 154 through the circulator 152. The receiver 154 may include an optical detector that detects the optical signal and converts it to an electrical signal. The receiver 154 may also include various filters as may be appropriate to optically and/or electrically filter the received signal before and after it is detected by the optical detector.

The receiver 154 is coupled to a processing system 156, which, among other components, may include one or more analog to digital converters to convert the electrical signals output by the detector to digital data. This data then may be stored in a memory 158 where it may be accessed by a processor 160 and used to provide information regarding measured parameters in the region of interest. More specifically, the processing system 156 may include software or algorithms configured to determine, based on the stored data, a vibration distribution along the DVS 102, differences in vibration relative to locations along the DVS 102, etc. Based on these determinations, information may be derived regarding characteristics of the fluid flow in the region of interest, such as flow rate, location, fluid composition, etc. In some embodiments, the information may then be used to assess the effectiveness of a well treatment and to adjust the treatment, if desired, to achieve a desired hydrocarbon production.

In systems in which multiple optical fibers are deployed and multiple parameters are measured in addition to vibration, such as temperature, pressure and strain, the processing system 156 also may be configured to determine temperature profiles, pressure profiles, strain locations, etc. This information may be evaluated in conjunction with the vibration measurements to provide an even more thorough understanding of events occurring in the region of interest.

In various embodiments of the invention, the processing system 156 may be coupled to the optical source 150 and the receiver 154 through a communication link 162, such as a network. In some embodiments, the processing system 156 also may be in communication with the well treatment system 138 and control and status signals may be exchanged between interrogation and data acquisition system 118 and well treatment system 138. In some embodiments, the well treatment system 138 also may include its own control system 164 having a processor or controller 166 and a memory 168 for controlling the treatment process independently of and/or based on information obtained from the processing system 156. In other embodiments, the processing system 156 may also control well treatment system 138, and control system 164 may be omitted.

In some embodiments, the processing system 156 and/or the control system 164 may be part of a control center. In one embodiment, the systems 156 and 164 may each comprise an input device and an output device. In addition to storing algorithms for determining various parameters based on the acquired data, the memory 158 and/or memory 168 may also store algorithms for controlling the optical source 150 and/or the optical receiver 154 and or the well treatment system 138. For instance, such algorithms may dictate the number of pulses to launch into the DVS 102, the time between launched pulses (i.e., the pulse repetition frequency), the pulse width, the rate at which signals should be sampled, etc. The algorithms may also determine the effectiveness of the well treatment and dictate adjustments and/or generate control signals for adjusting the treatment process. The input device may be a variety of types of devices, such as a keyboard, mouse, a touch screen, etc. The output device may include a visual and/or audio output device, such as a monitor having a graphical user interface.

Data and instructions (of the software used to implement any of the techniques described herein) are stored in respective storage devices (e.g., memories 158, 168), which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The processors 160 and 166 may be any type of processor, including a general-purpose microprocessor, a multi-core processor, microcontroller, programmable logic, etc.

In one embodiment, the interrogation and data acquisition system 118 may measure acoustic disturbances (i.e., vibration) by exploiting the properties of signals that have undergone Rayleigh backscattering when illuminated by a coherent optical pulse output by the optical source 150. As a probe pulse travels down the optical fiber (i.e., DVS 102), the pulse continuously loses light to variety of processes, such as absorption, but also to Rayleigh scattering. The latter process is the result of microscopic (i.e., much smaller than the probe wavelength) inhomogeneities in the material forming the fiber that re-direct light in all directions. Some of the light thus scattered falls within the acceptance angle of the fiber in the return direction (i.e., it is trapped by the guiding structure of the fiber and may be carried back to the launching end).

The backscattered signal takes the form of a generally decaying exponential waveform in which the rate of decay may be directly related to the attenuation of the fiber, with however, additional information on local properties of the fiber, such as the core diameter, numerical aperture, scattering loss and so on. The time between launching of the probe pulse and observing the backscattered signal may be directly related to the position or location at which that light was scattered. Accordingly, the backscatter technique may allow the rate of attenuation to be evaluated as a function of distance along the fiber, together with detecting anomalies, such as poor splices, mismatched fibers and so on.

The foregoing example has tacitly assumed that the optical bandwidth of the probe pulse is sufficiently wide that the scattered light from each part of the section of fiber occupied by the probe pulse (hereafter referred to as a resolution cell because it defines the smallest section of fiber that can be distinguished along the fiber) is not coherently related to light from other parts of that section. Therefore, the contributions from each elemental part of such fiber sections add in intensity at the detector where the backscatter signal is converted from an optical to the electrical domain.

If however, the probe pulse has a narrow spectrum and the light from all parts of that pulse are coherently related, then the backscattered contributions from each elemental part of the resolution cell add coherently, i.e., their electric field vectors are summed at the detector and the electrical signal thus obtained depends on the relative phase of these contributions. The resultant electrical signal, when measured as a function of distance along the fiber, takes the form of a jagged trace, with an exponential envelope. The jagged appearance is the result of the fact that in some locations the electric fields within a resolution cell add coherently, while in others they cancel. In other words, the light within a resolution cell can interfere constructively or destructively (or sum to any intermediate value). The interference condition depends on the relative phase of each of a vast number of scattering elements within the resolution cell.

The location of these scatterers is random (it is dictated by random thermodynamic fluctuations of density and glass composition when the fiber was drawn from molten glass) and their relative phase depends in addition on the optical frequency of the probe pulse. If the probe laser frequency is very stable and remains consistent over a wide number of pulses, then the jagged pattern of the coherent Rayleigh backscatter, while random, remains stable. However, if the fiber is disturbed (e.g., strained or heated), the phase relationship between scatterers changes and thus so too does the backscatter signal in the region where the fiber has been disturbed. Although the coherent backscatter signal is random, changes in its state can nonetheless be used to detect fluctuations, e.g., caused by dynamic strain in the fiber.

The backscatter signal may be sent to a detector (so called direct detection), or mixed with a sample of the source taken prior to the probe pulse being extracted (coherent detection). In coherent detection, the signal reaching the detector is then the product of the electric field amplitude of the backscatter signal and the amplitude of the sample of the source (so called local oscillator). Both methods may be suitable for practicing embodiments of the present invention.

Although the use of coherent Rayleigh backscattering may be a preferred approach, it is recognized that the resulting signal is relatively weak. In order to provide a stronger signal, it may be desirable to augment the scattered signals through the use of discrete reflectors, such as mildly reflective splices or fiber Bragg gratings formed along the length of the optical fiber using known techniques. The resulting array of reflectors has similarities to approaches used for sonar arrays and may be interrogated in ways known to those experienced in optical fiber interferometric sensor arrays.

As yet another example, the interrogation and data acquisition system may employ a broadband optical source followed by an unbalanced interferometer to launch a pair of interrogation signals into the sensing optical fiber. A pair of backscattered signals (e.g., Rayleigh backscatter) are returned back through the unbalanced interferometer and combined into a combined signal from which information relating to fluid flow or other disturbances along the optical fiber may be derived.

It should further be understood that the particular interrogation and data acquisition techniques discussed herein are provided as examples only and that any of a variety of interrogation and acquisition techniques may be implemented to obtain information regarding fluid flow using a distributed vibration sensor, including detecting signals produced by the DVS 102 other than or in addition to Rayleigh backscatter signals.

Distributed vibration sensing may be used to identify a number of properties of a treatment process. For example, the flow noise caused by the movement of fluids in the well may be used to identify regions where there is flow and regions where none exists. Although the flow noise is not simply related to flow rate, it is known that with increasing flow rate, the spectrum of the flow noise broadens and that the noise spectral density of the acoustic signals also increases. One or both of these properties of the acoustic signal may be used, together with at least an empirical relationship to flow, to identify the local flow conditions. As a result, a determination may be made as to whether the treatment is addressing the intended parts of the well. In some embodiments, the determination may be made by an operator that is conducting the well treatment process. Alternatively, the determination may be made by a processing system (e.g., processing system 156 or control system 164) which may output the information to either the operator or use the information to provide control signals to the well treatment system 138 to adjust or otherwise control the treatment process.

In addition, identifying where the flow will leave or enter the wellbore at a variety of locations and identifying the transverse flow can be performed in a number of ways. Firstly, high flow rate, for example such as through perforations, will result in a whistling effect as a result of the passage of the fluid through relative narrow apertures. Secondly, in some cases, the fiber can be arranged so that fluid entering or leaving the well flows transversely across the fiber or optical cable, giving rise to vortex shedding. Vortex shedding results in a well-defined sound that is imparted as a periodic distortion to the fiber and can be read at the surface.

Understanding the flow in each section of the well may provide a real-time indication of the path taken by the fluid. In addition, understanding the flow may also provide a direct feedback to the surface as to the effectiveness of treatments, such as diversion or acidizing, fracturing and so on. As a result, the treatment process may be varied in real time (e.g., manually, automatically, or semi-automatically), such as by altering the flow rate (or pressure) of the treatment material, by terminating the process at an optimum time, by varying the treatment material to optimize the effectiveness of the treatment, etc. Alternatively, the treatment process may be varied by performing a different type of treatment or by operating various downhole components. For example, during a fracturing operating, gaining an indication of which zones are accepting the fracturing fluid may allow a diversion process to be implemented. The diversion process may ensure that those zones which were originally planned to be subjected to treatment, but for some reason were not treated in practice, would then benefit from a diversion process. The diversion process may also limit the treatment of zones previously treated by the initial process. For example, the diversion process may be implemented by operating downhole valves or packers, blocking certain paths with parts or other objects dropped from the surface, or even by altering the nature of the pumped fluid.

FIG. 4 is a flow diagram illustrating an exemplary technique for assessing the effectiveness of a well treatment using a distributed vibration sensor. As shown in FIG. 4, a distributed vibration sensor (e.g., DVS 102) is deployed in a well and positioned to monitor fluid flow in a region of interest (block 170). A well treatment, including any of the treatments discussed herein, is performed (block 172). A vibration measurement from the region of interest is acquired from the vibration sensor (block 174) and an indication of the effectiveness of the well treatment is provided based on the acquired measurement (block 176). In some embodiments, the well treatment may be adjusted, if desired, to obtain a desired fluid flow (block 178). It should be understood that the steps shown in FIG. 4 are exemplary only and that fewer, additional, or different steps may be performed and that the steps may be performed in a different order, while still falling within the scope of the invention.

Noise tools may be conventionally used in the field of hydrocarbon production to detect and locate flow behind the casing (an issue of well integrity). Embodiments of the distributed vibration sensing techniques described herein may be used in place of a noise tool in either a permanent deployment or in an intervention mode.

Of course, the distributed vibration sensing approach described above can be complemented by other measurements that may, in some cases, be implemented on the same fiber, or on different fibers in the same cable. For example, a distributed temperature measurement may provide information on which zones have accepted treatment fluid by using a warm-back or hot-slug method. A downhole pressure sensor may allow the progress of a fracturing operation to be monitored more effectively than from the surface. The downhole pressure sensor may eliminate the effects of time-lag, possible variation of the hydrostatic head, or frictional pressure drop, and the bottom-hole pressure may be measured directly in the vicinity of the treatment.

In the foregoing description, numerous details are set forth to provide an understanding of the illustrative embodiments of the present invention. However, it will be understood by those skilled in the art that some embodiments of the present invention may be practiced without these details. While various aspects of the invention have been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system comprising:
a fiber optic cable deployed in a wellbore proximate a region of interest;
an optical source to launch an optical pulse into the fiber optic cable;
an optical receiver to receive a backscattered optical signal produced from the fiber optic cable in response to the light pulse; and
a processing system configured to determine a distribution of vibration with respect to location along the fiber optic cable based on the backscattered signal.

2. The system as recited in claim 1, comprising:
a well treatment system to perform a well treatment in the wellbore to stimulate fluid flow, wherein the processing system is further configured to provide a determination of an effectiveness of the well treatment based on the distribution of vibration.

3. The system as recited in claim 2, further comprising a second optical cable deployed in the wellbore to sense a distribution of temperature in the region of interest

4. The system as recited in claim 2, wherein the well treatment system is configured to deploy a conduit into the wellbore to transport a material for performing the well treatment.

5. The system as recited in claim 4, wherein the fiber optic cable is deployed in the conduit.

6. The system as recited in claim 2, wherein the well treatment system is configured to convey a treatment material into the wellbore to perform the well treatment.

7. The system as recited in claim 6, wherein the fiber optic cable is deployed in the treatment material.

8. A method for monitoring a fluid flow in a wellbore, comprising:
providing in the wellbore a distributed vibration sensor, wherein the distributed vibration sensor is positioned to sense a distribution of vibration along a section of the well;
performing a well treatment involving transporting a material into the well;
monitoring output of the distributed vibration sensor for the section of the well; and
providing an indication of a level of effectiveness of the well treatment from the output.

9. The method as recited in claim 8, further comprising adjusting the well treatment based on the indication of the level of effectiveness.

10. The method as recited in claim 9, wherein adjusting the well treatment comprises at least one of terminating the treatment, initiating a different treatment, varying a treatment material, and varying a flow rate of a treatment material.

11. The method as recited in claim 8, wherein monitoring the output of the distributed vibration sensor is performed during performance of the well treatment.

12. The method as recited in claim 8, wherein performing the well treatment comprises deploying in the wellbore a conduit to transport the treatment material.

13. The method as recited in claim 12, wherein the distributed vibration sensor is deployed in the conduit.

14. The method as recited in claim 8, further comprising providing in the wellbore a distributed temperature sensor to provide a temperature distribution in the region of interest.

15. The method as recited in claim 14, wherein providing the indication of the level of effectiveness comprises correlating the temperature distribution with the distribution of vibration.

16. A method usable in a wellbore, comprising:
positioning a distributed vibration sensor to measure vibration in a region of interest in a well;
acquiring from the distributed vibration sensor a distribution of vibration along the region of interest resulting from a well treatment process; and
providing a determination of a level of effectiveness of the well treatment process based on the distribution of vibration.

17. The method as recited in claim 16, wherein the distributed vibration sensor comprises an optical fiber, and wherein acquiring the distribution of vibration comprises:
launching an optical signal into the optical fiber;
detecting a backscattered signal produced by the optical fiber in response to the optical signal; and
determining the distribution of vibration based on the detected backscattered signal.

18. The method as recited in claim 17, wherein the launched optical signal is a pulse of light, and wherein detecting the backscattered signal comprises detecting Rayleigh backscatter produced in response to the pulse of light.

19. The method as recited in claim 16, further comprising:
performing the well treatment process; and
adjusting performance of the well treatment process based on the indication of the effectiveness of the well treatment process.

20. The method as recited in claim 19, further comprising acquiring the distribution of vibration during performance of the well treatment process.
